(19) United States
(12) Patent Application Publication
(10) Pub. No.: US 2013/0044938 A1
(43) Pub. Date: Feb. 21, 2013

(54) MEASUREMENT SYSTEM USING ALIGNMENT SYSTEM AND POSITION MEASUREMENT METHOD

(71) Applicants: Sung Min AHN, Suwon-si (KR); Tae Kyu Son, Seongnam-si (KR)

(72) Inventors: Sung Min AHN, Suwon-si (KR); Tae Kyu Son, Seongnam-si (KR)

(73) Assignee: Samsung Electronics Co., Ltd., Suwon-si (KR)

(21) Appl. No.: 13/584,127

(22) Filed: Aug. 13, 2012

(30) Foreign Application Priority Data
Aug. 19, 2011 (KR) 10-2011-0083026

(51) Int. Cl. G06K 9/00

(52) U.S. Cl. 382/151

(57) ABSTRACT

Disclosed herein are a system of measuring position information of a workpiece, such as a substrate (or a semiconductor wafer) using one or more alignment systems, and a position measurement method using the same. Positions of respective alignment systems are calculated using multiple fiducial marks (FMs) disposed on a fiducial alignment scope unit mark array (FAA) on a table, and positions of alignment marks (AMs) disposed on the workpiece are measured by moving the table so that the AMs are located within a field of vision (FOV) of the alignment system. The position information of the workpiece is measured using the position information of the alignment system and the position information of the FMs.

### CROSS-REFERENCE TO RELATED APPLICATION

This application claims priority from and the benefit of Korean Patent Application No. 2011-0083026, filed on Aug. 19, 2011, the disclosure of which is incorporated herein by reference.

### BACKGROUND

1. Field

The following description relates to a system and method for measuring position and posture of a workpiece, such as a substrate (or a semiconductor wafer) using one or more alignment systems.

2. Discussion of Background

In general, in fields of processing, manufacturing, or testing workpieces, such as substrates (or semiconductor wafers), which may be used to manufacture various displays including liquid crystal displays (LCDs), plasma display panels (PDPs) or flat panel displays (FPDs), a position and posture of the workpiece may be detected in advance. For this purpose, the position and posture of the workpiece may be measured using an alignment scope unit, such as a micro-scope system.

In the case in which the position and posture of the workpiece are measured using the alignment scope unit, the alignment scope unit may be mounted on a moving table on which the workpiece is placed so that lengthwise and widthwise directions of the alignment scope unit coincide with those of the moving table. Accordingly, the position and posture information of the workpiece may be measured with a certain level of precision.

However, if the alignment scope unit is actually mounted on the moving table, the lengthwise and widthwise directions of the alignment scope unit may not coincide with those of the moving table as designed. Therefore, in order to calibrate the alignment scope with the moving table, the position of the mounted alignment scope unit may be first detected. More particularly, if multiple alignment scope units are installed in order to measure position and posture information of the workpiece within a reference period of time, positions of the respective alignment scope units may be detected to measure the position and posture of the workpiece.

The above information disclosed in this Background section is only for enhancement of understanding of the background of the invention and therefore it may contain information that does not form any part of the prior art nor what the prior art may suggest to a person of ordinary skill in the art.

### SUMMARY

Exemplary embodiments of the present invention provide a system and method for measuring position and posture of a workpiece, such as a substrate (or a semiconductor wafer), using one or more alignment systems.

Additional aspects of the invention will be set forth in part in the description which follows and, in part, will be obvious from the description, or may be learned by practice of the invention.

Exemplary embodiments of the present invention provide a method for measuring position information of a workpiece including measuring position information of a first fiducial mark (FM) using an alignment system; calculating position information of the alignment system corresponding to a position of a table, in which the second FM is detected within a field of vision (FOV) of the alignment system; acquiring image information of the workpiece using the alignment system; acquiring position information of alignment marks (AMs) disposed on the workpiece using position information of the table; and measuring position information of the workpiece using the position information of the AMs.

Exemplary embodiments of the present invention provide a measurement system including a table to support a workpiece; a FAA including a first FM and a second FM, the FAA disposed on the table; an alignment system configured to measure position information of the first FM; and a control unit configured to calculate position information of the alignment system corresponding to a position of the table, to acquire image information of the workpiece using the alignment system, to acquire position information of AMs on the workpiece based on the position of the table, and to calculate the position information of the workpiece using the position information of the AMs, in which the position of the table corresponds to a position where the second FM is detected within a FOV of the alignment system.

Exemplary embodiments of the present invention provide a measurement system including a workpiece including a plurality of AMs; a FAA including a first FM and a second FM; an alignment system configured to measure position information of the first FM; and a control unit configured to calculate position information of the alignment system by detecting the second FM to be within a FOV of the alignment system, and to acquire position information of the workpiece by detecting the AMs to be within the FOV of the alignment system.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a view illustrating a configuration of a measurement system according to an exemplary embodiment of the present invention.

FIG. 2 is a view illustrating an operation of a measurement system according to an exemplary embodiment of the present invention.

FIG. 3 is a view illustrating a moving table on which a fiducial alignment scope unit mark array (FAA) is mounted in a measurement system according to an exemplary embodiment of the present invention.

FIG. 4 is a table illustrating correction of manufacturing errors of respective identifiers of FAA relative to nominal positions in a measurement system according to an exemplary embodiment of the present invention.

FIG. 5 is a view illustrating a configuration of a measurement system according to an exemplary embodiment of the present invention.

FIG. 6 is a view illustrating a position of a mark measured by a k^{th} alignment system installed on the measurement system according to an exemplary embodiment of the present invention.

FIG. 7 is a view illustrating a position of a mark measured by a k^{th} alignment system installed on the measurement system according to an exemplary embodiment of the present invention.

FIG. 8 is a view illustrating a process of acquiring position coordinates of an alignment system using fiducial marks (FMs) in a measurement system according to an exemplary embodiment of the present invention.

FIG. 9 is a view illustrating a measurement system with an allowable transfer distance of a stage equal or longer than an interval between alignment systems according to an exemplary embodiment of the present invention.

FIG. 10 is a view illustrating a measurement system with an allowable transfer distance of a stage shorter than an interval between alignment systems according to an exemplary embodiment of the present invention.

FIG. 11 is a view illustrating a method for acquiring central position coordinates of an alignment system using FAA on which FMs are engraved in a measurement system in accordance with the embodiment of the present invention.

FIG. 12 is a view illustrating a method for acquiring alignment marks engraved on a workpiece using alignment systems in a measurement system according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

It will be understood that if an element is referred to as being “connected to” another element, it can be directly connected to the other element, or intervening elements may be present.

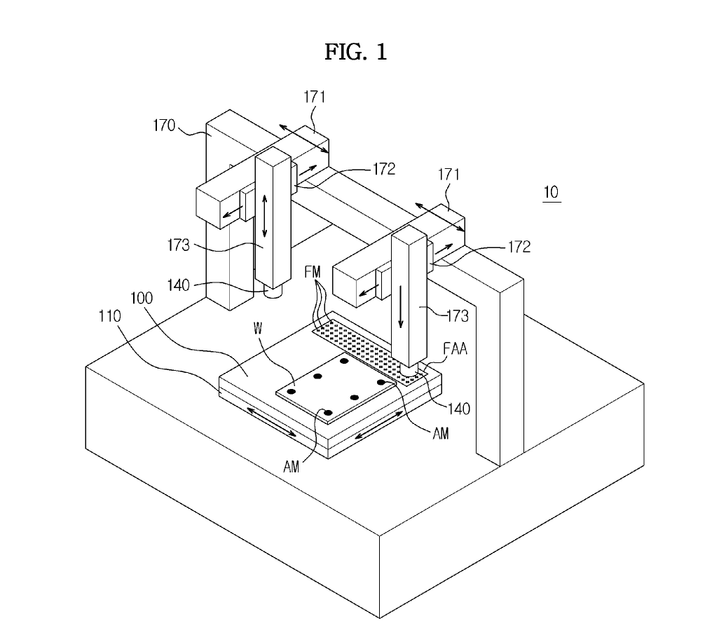

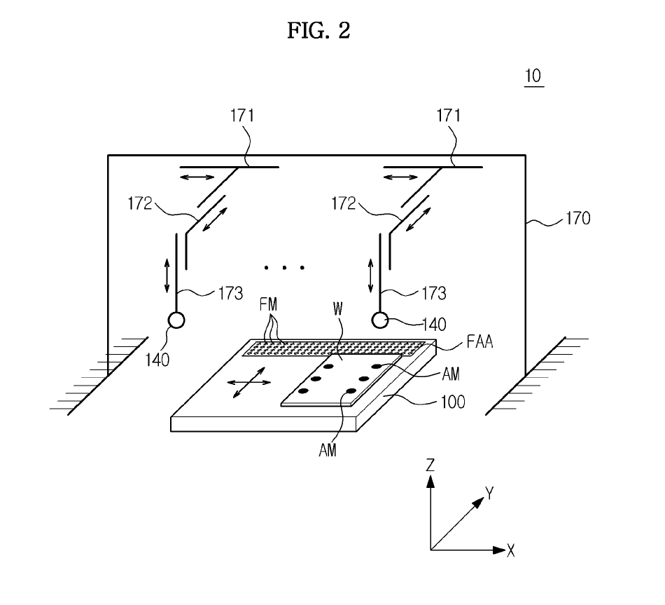

FIG. 1 is a view illustrating a configuration of a measurement system according to an exemplary embodiment of the present invention. FIG. 2 is a view illustrating an operation of a measurement system according to an exemplary embodiment of the present invention.

As shown in FIG. 1 and FIG. 2, a measurement system 10 includes a moving table 100 on which a workpiece (any sample upon which a designated pattern may be formed, such as a semiconductor wafer or a glass substrate) W is mounted, and multiple alignment systems 140 located above the moving able 100 to measure a position and posture of the workpiece W mounted on the moving table 100. The alignment systems 140 are installed on a gantry 170, which may allow mobility in X-axis direction, Y-axis direction and Z-axis direction. The alignment systems 140 having 3 degrees of freedom (X, Y, Z) may be common. Other alignment systems 140 may have one or more degrees of freedom of the alignment systems 140 be restricted in some cases. For example, the alignment systems 140 may have 2 degrees of freedom to be movable in the X-axis direction and Z-axis direction, 1 degree of freedom to be movable in the X-axis direction, or other degrees of freedom according to other combinations of the directions.

Moving member 171, moving member 172 and moving member 173 may be a guide bar type, which may be capable of moving in the X-axis direction, Y-axis direction and Z-axis direction. The moving members are installed on the gantry 170. Further, the alignment systems 140 are connected to the moving member 171, moving member 172 and moving member 173 to be movable in the X-axis direction, Y-axis direction and Z-axis direction.

The respective alignment systems 140 may have 3 degrees of freedom (X, Y, Z) to be movable in the X-axis direction, Y-axis direction and Z-axis direction according to operation of the moving member 171, moving member 172 and moving member 173. Further, the moving table 100 on which the workpiece W is mounted may have 2 degrees of freedom (X, Y) to be movable in the X-axis direction and Y-axis direction according to operation of the stage 110.

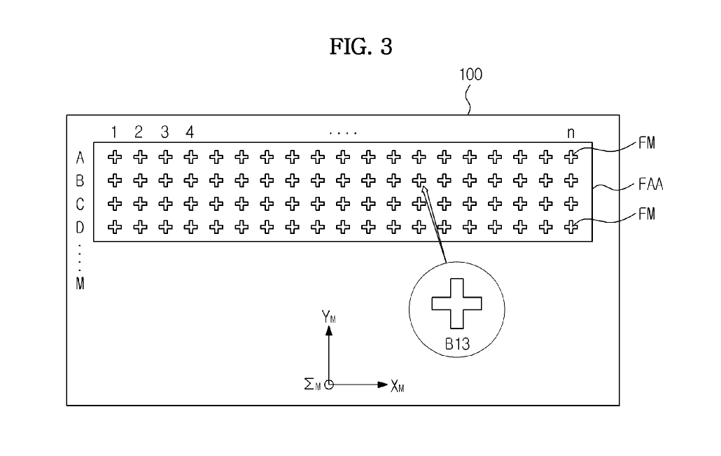

Further, a fiducial alignment scope unit mark array (FAA), on which multiple fiducial marks (FMs) are engraved in an array to measure positions of the respective alignment systems 140, is mounted on the moving table 100. The FAA will be described with reference to FIG. 3.

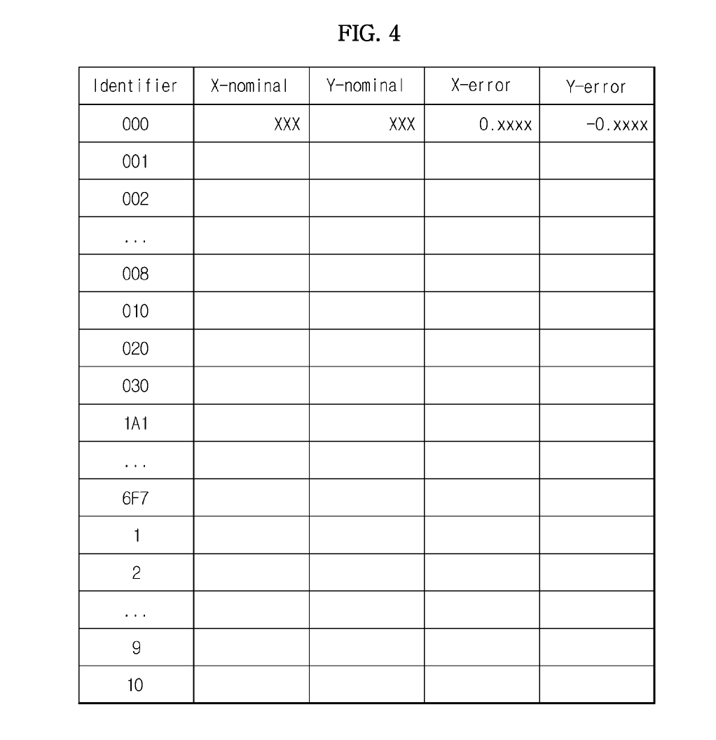

FIG. 3 is a view illustrating a moving table on which a FAA is mounted in a measurement system according to an exemplary embodiment of the present invention, and FIG. 4 is a table illustrating correction of manufacturing errors of respective identifiers of FAA relative to nominal positions in a measurement system according to an exemplary embodiment of the present invention.

As shown in FIG. 3, the FAA includes multiple FMs to measure the positions of the alignment systems 140, which may acquire position coordinates (e.g., central coordinates) of the respective alignment systems 140. Multiple FMs are arranged in an array and mounted on the moving table 100.

Multiple FMs are engraved on the FAA in a 2-dimensional array (M(rows)×n(columns)) with a designated interval. Multiple FMs may be used as fiducial alignment marks to acquire position coordinates of the respective alignment systems 140. Manufacturing errors of respective identifiers of the FMs engraved on the FAA in the 2-dimensional array relative to nominal positions (e.g., an identifier B13 corresponding to an FM of a row B and a column 13) may be measured and serve as fiducial alignment marks. The manufacturing errors may be corrected using the correction table containing correction information, as shown in FIG. 4.

Arrangement of the FAA within a reference vicinity or area range of the alignment systems 140 may be effective.

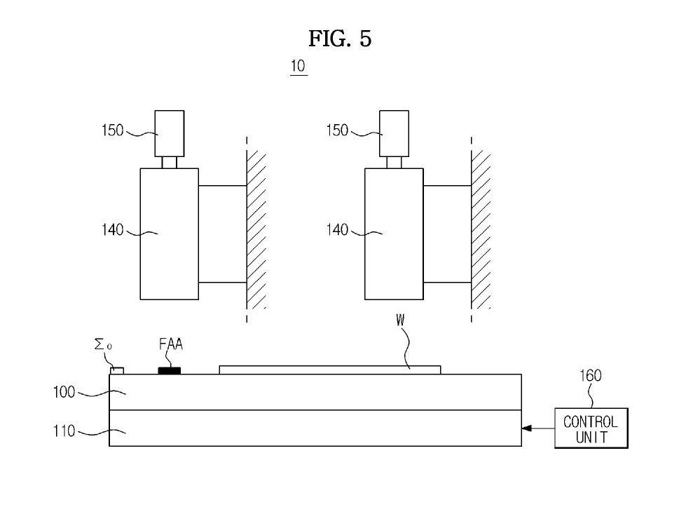

FIG. 5 is a view illustrating a configuration of a measurement system according to an exemplary embodiment of the present invention.

As shown in FIG. 5, the measurement system 10 includes a stage 110, multiple alignment systems 140, multiple mark photographing units 150, and a control unit 160.

The stage 110 may serve to transfer the moving table 100, on which the workpiece W is mounted, in an X-axis direction and Y-axis direction. The stage 110 may transfer or move the moving table 100 according to instructions from the control unit 160 so that the FMs engraved on the FAA on the moving table 100 or alignment marks (AMs) may be located within fields of view (FOVs) of the alignment systems 140.

The alignment systems 140 are provided above the stage 110, and may include alignment scope units (ASUs), which may be used to measure positions of the FMs engraved on the FAA on the moving table 100 and the AMs engraved on the workpiece A.

The mark photographing units 150 are provided or disposed above the alignment systems 140. The mark photographing units 150 may photograph the FMs engraved on the FAA on the moving table 100 and the AMs engraved on the workpiece A, and transmit photographed images to the control unit 160. Movement of the stage 110 may be controlled until the FMs and the AMs are photographed by the mark photographing units 150 according to instructions from the control unit 160.

The control unit 160 may acquire position coordinates of the respective alignment systems 140 using the FMs engraved on the FAA on the moving table 100. The control unit 160 may measure positions of the AMs through the respective alignment systems 140 by transferring the moving table 100 so that the AMs engraved on the workpiece W are located within the FOVs of the alignment systems 140. Thereafter, the control unit 160 may measure the position and posture of the workpiece W according to the position coordinates of the respective alignment systems 140 and the positions of the AMs measured by the respective alignment systems 140.

Hereinafter, a method for measuring the position and posture of the workpiece W in a measurement system including one or more alignment systems 140 will be described.

Prior to measurement of the position and posture of the workpiece W, positions of the FMs with respect to installation errors, if any, of the respective alignment systems 140 and positions of the respective alignment systems 140 may be acquired.

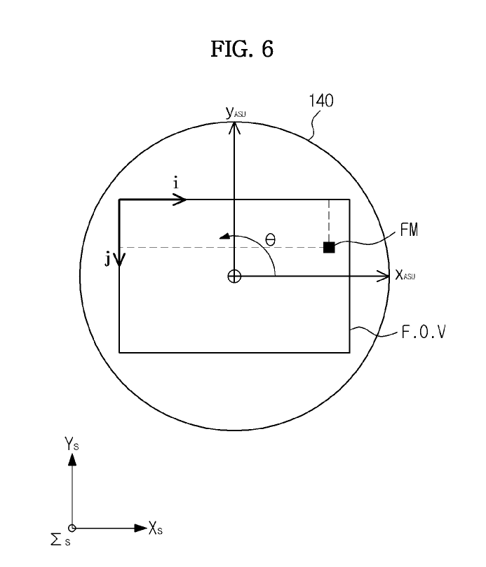

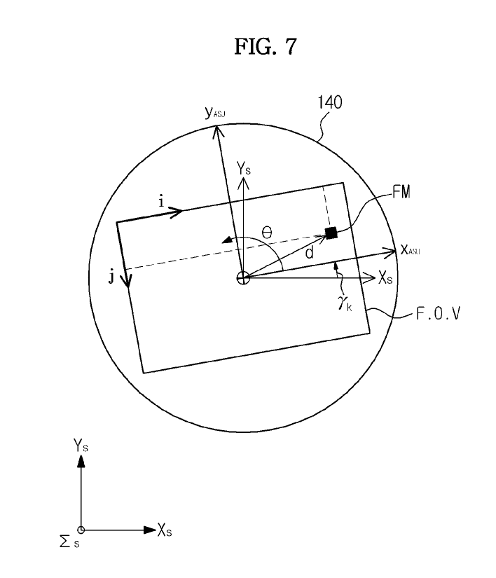

First, a method for measuring positions of the FMs with respect to the installation errors of the respective alignment systems 140 will be described with reference to FIG. 6 and FIG. 7.

FIG. 6 is a view illustrating a position of a mark measured by a k^{th} alignment system installed on the measurement system according to an exemplary embodiment of the present invention. FIG. 7 is a view illustrating a position of a mark measured by the k^{th} alignment system installed on the measurement system according to an exemplary embodiment of the present invention.

As shown in FIG. 6 and FIG. 7, the k^{th} alignment system 140 measures an FM engraved on the FAA on the moving table 100 through the FOV of the k^{th} alignment system 140. In an example, the FM may be measured, without limitation, according to coordinate systems provided below.

ΣS(XS, YS) may refer to a stage coordinate system, which may be a fixed body coordinate system of the stage 110 (hereinafter, referred to as a stage coordinate system).

ΣASU(ΣV) may refer to an image coordinate system, which may be a body fixed coordinate system of the k^{th} alignment system 140 (hereinafter, referred to as an image coordinate system).

Here, k may be a value equal to a whole number (e.g., 0, 1, 2, . . . k).

FIG. 6 illustrates a k^{th} alignment system 140, without installation error. In this case, the posture of the k^{th} alignment system 140 coincides with the stage coordinate system Σ_{S} (i.e., the installation error γₖ of the k^{th} alignment system 140 is 0).

Installation error γₖ may be described as unit conversion factors (Sᵢ, Sⱼ) with respect to directions (i, j) in a FOV acquired by the k^{th} alignment system 140. Further, installation error γₖ may refer to an angle of rotation deviated from a stage coordinate system Σ_{S}.

In a case in which the installation error γₖis 0, position ^{AUSk}d of the FM measured by the k^{th} alignment system 140 with respect to the stage coordinate system Σ_{S} may be defined by Equation 1 below (with reference to FIG. 6).

$${}^{ASUk} d = [ \begin{matrix}{x}_{ASU} \\ {y}_{ASU}\end{matrix} ] , \{ \begin{matrix}{x}_{ASU} ≡ {S}_{i} \cdot ( i - \frac{I}{2} ) \\ {y}_{ASU} ≡ - {S}_{j} \cdot ( j - \frac{J}{2} )\end{matrix} \qquad [ Equation 1 ]$$

In Equation 1, i is a pixel index of 0˜I, j is a pixel index of 0˜J, and Sᵢ and Sⱼ are scale vectors [nm/pixel] in the directions i and j.

FIG. 7 illustrates the k^{th} alignment system 140 with an installation error. In this case, the k^{th} alignment system 140 is assembled and installed with an installation error γₖ with respect to the stage coordinate system Σ_{S}.

In a case in which the installation error γₖ is not 0, the position ^{S}d of the FM measured by the k^{th} alignment system 140 with respect to the stage coordinate system Σ_{S} (i.e., image information ^{S}d acquired by the k^{th} alignment system 140), may be calculated, without limitation, by Equation 2 below (with reference to FIG. 7).

^{S}d=R(γₖ)·^{ASUk}d [Equation 2]

In Equation 2, γₖ is an installation error of the k^{th} alignment system 140, and R may refer to a rotation and transformation matrix, in which

$$R ( {γ}_{k} ) = [ \begin{matrix}cos {γ}_{k} & - sin {γ}_{k} \\ sin {γ}_{k} & cos {γ}_{k}\end{matrix} ] .$$

In general, the respective alignment systems 140 may not installed under the condition that the postures of the alignment systems 140 coincide with the stage coordinate system Σ_{S}, as shown in FIG. 6, but are installed under the condition that the alignment systems 140 are rotated from the stage coordinate system Σ_{S} at angles of installation errors γₖ, as shown in FIG. 7.

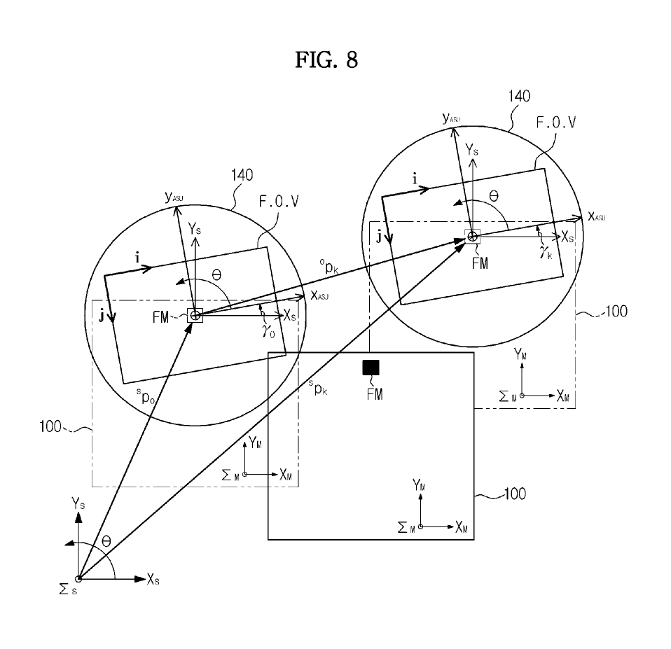

The respective alignment systems 140 may not measure position and posture of the workpiece W mounted on the moving table with a reference level of precision due, in part, to such installation errors γₖ. Accordingly, position coordinates of the alignment systems 140 installed with respective installation errors γₖ may be acquired. This operation will be described with reference to FIG. 8.

FIG. 8 is a view illustrating a process of acquiring position coordinates of an alignment system using FMs in a measurement system according to an exemplary embodiment of the present invention.

Referring to FIG. 8, multiple alignment systems 140 with installation errors γₖ are used. Here, the case in which one FM is engraved on the moving table 100 is exemplarily described.

The moving table 100 may be transferred from a first position to a second position so that the FM engraved on the moving table 100 is located within the FOVs of the respective alignment systems 140 (e.g., the FOV of the k^{th} alignment system). Central position coordinates ^{S}Pₖ of the respective alignment systems 140 with respect to the stage coordinate system Σ_{S} may be calculated by acquiring coordinates of the moving table 100 through a feedback signal of the stage 110 if the FM is located within the centers of the FOVs of the respective alignment systems 140.

Using the same method, central position coordinates ^{S}P₀ of the 0^{th} alignment system 140 are calculated.

If the position of the FM according to the installation errors γₖ of the respective alignment systems 140 and the central position coordinates ^{S}Pₖ of the respective alignment systems 140 are acquired, as described above, positions of the AMs engraved on the workpiece W may be acquired using the respective alignment systems 140.

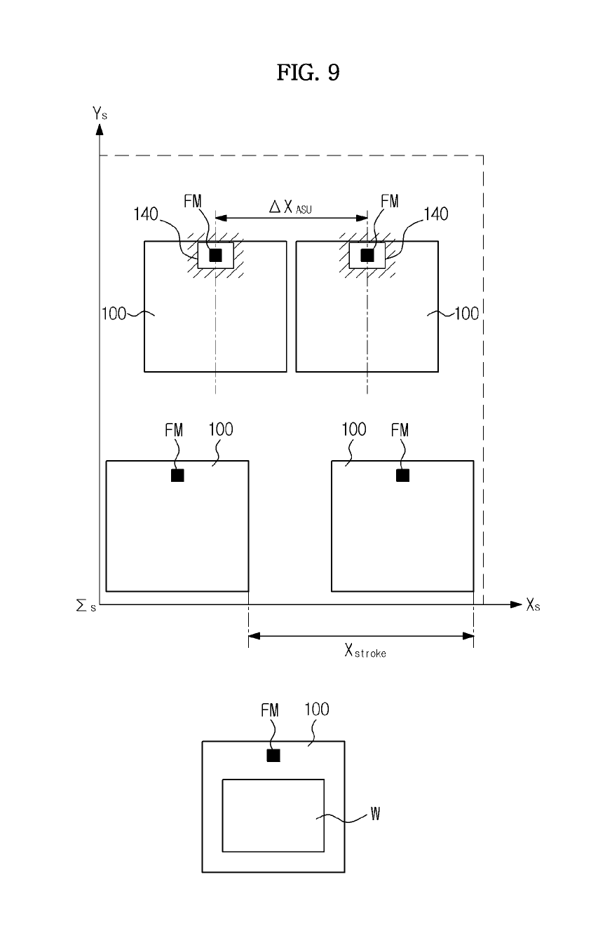

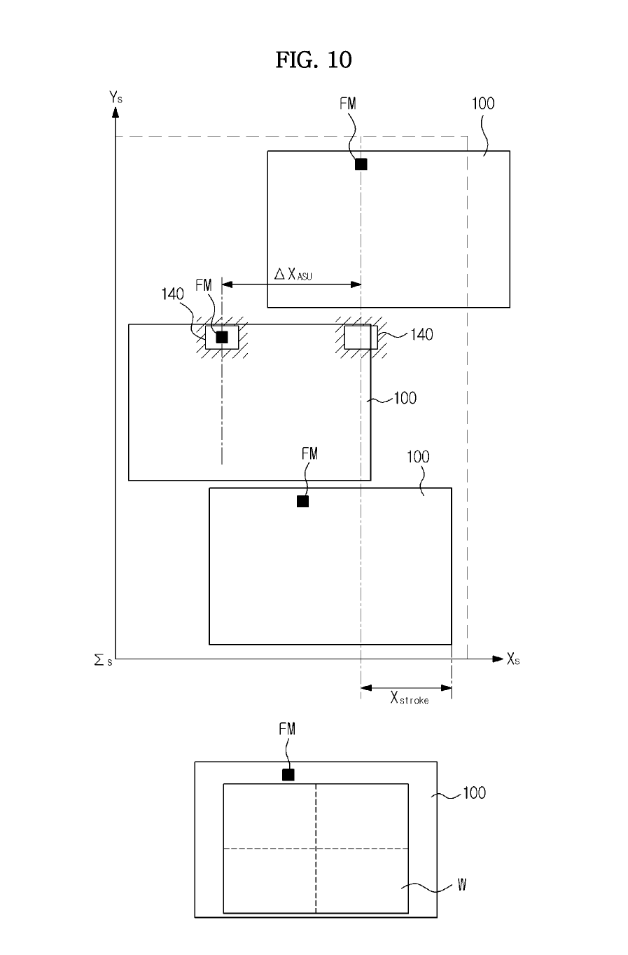

As described above, the central position coordinates ^{S}Pₖ of the respective alignment systems 140 may be acquired using the FM engraved on the moving table 100. This will be described in detail with reference to FIG. 9 and FIG. 10.

FIG. 9 is a view illustrating a measurement system with an allowable transfer distance of a stage equal or longer than an interval between alignment systems according to an exemplary embodiment of the present invention.

In FIG. 9, if a stroke or displacement of the moving table 100 is equal to or longer than a distance between the respective alignment systems 140 (i.e., if a stroke Xₛₜᵣₒₖₑ of the stage 110 is equal to or longer than an interval ΔX_{ASU} between the respective alignment systems 140) in a case where the moving table 100 is transferred so that the FMs engraved on the moving table 100 are located within the FOVs of the respective alignment systems 140, the central position coordinates of the respective alignment systems 140 may be acquired.

FIG. 10 is a view illustrating a measurement system with an allowable transfer distance of a stage shorter than an interval between alignment systems according to an exemplary embodiment of the present invention.

In FIG. 10, if a stroke or displacement of the moving table 100 is shorter than a distance between the respective alignment systems 140 (i.e., if the stroke Xₛₜᵣₒₖₑ of the stage 110 is shorter than the interval ΔX_{ASU} between the respective alignment systems 140) in a case where the moving table 100 is transferred so that the FMs engraved on the moving table 100 are located within the FOVs of the respective alignment systems 140, the central position coordinates of the respective alignment systems 140 may not be acquired.

As the workpiece W, such as a wafer or a glass substrate, increases, the footprint (the size) of equipment may be increased. However, as the size of the equipment is increased, various constraints, such as difficulty in manufacture of the equipment, increase in management costs within a clean room, and level of difficulty in a correction technique according to increase in the stroke of the stage 110 may occur. Therefore, technical development towards reduction in the footprint of the equipment while obtaining a processing capacity of the equipment to the workpiece W, such as a large-sized glass substrate, may be carried out. Exemplary embodiments of the present invention provide a method for acquiring central position coordinates of one or more alignment systems 140 in a processing equipment to satisfy these constraints.

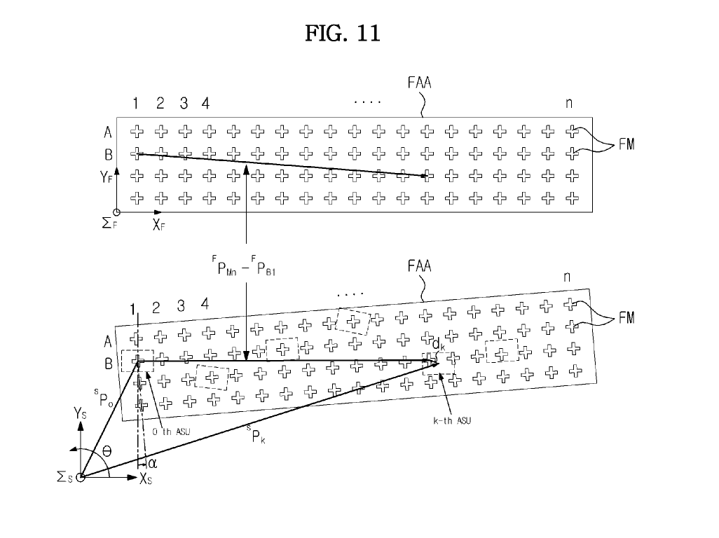

For this purpose, a method for acquiring central position coordinates of the respective alignment systems 140 using one or more FMs engraved on the FAA on the moving table shown in FIG. 4 will be described with reference to FIG. 11.

FIG. 11 is a view illustrating a method for acquiring the central position coordinates of an alignment system using FAA on which FMs are engraved in a measurement system according to an exemplary embodiment of the present invention.

In FIG. 11, physical quantities or a coordinate system to acquire central position coordinates of one or more alignment systems 140 using FAA, on which FMs are engraved is described below.

Σ_{FAA}(Σ_{F}) may be a fixed body coordinate system of the FAA (hereinafter, referred to as an array coordinate system).

Referring to FIG. 11, one or more alignment systems 140 with installation errors γₖ are described. Here, the central position coordinates of the respective alignment systems 140 with respect to the stage coordinate system Σ_{S} are referred to as “^{S}P_{k=0.1, . . .} ”.

^{S}P₀ may correspond to a central position coordinates of the 0^{th} alignment system 140, and may be acquired by transferring the moving table 100 so that a random FM (in this embodiment, an FM B1 corresponding to a row B and a column 1) of the FAA is located within the FOV of the 0^{th} alignment system 140. In an example, the random FM of the FAA may be located within a central region of the FOV of the 0^{th} alignment system 140.

Further, ^{S}Pₖ (k>0) may correspond to a central position coordinates of k^{th} alignment system 140, which may be acquired through Equation 3 below by reading a random FM (e.g., an FM Mn that corresponds to a row M and a column n) of the FAA located within the FOV of the k^{th} alignment system 140. Further, the random FM of the FAA may be read under the condition that the moving table 100 is stopped. The central position coordinates of the k^{th} alignment system 140 may be acquired after acquiring the central position coordinates ^{S}P₀ of the 0^{th} alignment system 140.

^{S}pₖ=^{S}p₀+R(α)·(^{F}p_{Mn}−^{F}p_{B1})−R(γₖ)·^{ASUk}dₖ [Equation 3]

In Equation 3, ^{F}P_{Mn} and ^{F}P_{B1} may refer to position vectors correcting manufacturing errors present in the correction table of FIG. 4. ^{F}P_{Mn} may refer to a position vector of an “Mn” FM (an FM that corresponds to a row M and a column n and has an identifier of “Mn”) with respect to the array coordinate system Σ_{F}. ^{F}P_{B1} may refer to a position vector of a “B1” FM (an FM that corresponds to a row B and a column 1 and has an identifier of “B1”) with respect to the array coordinate system Σ_{F}.

Further, α may refer to an assembly error angle of the FAA mounted on the moving table 100 with respect to the stage coordinate system Σ_{S}. γₖ may refer to an assembly error angle of the k^{th} alignment system 140 with respect to the stage coordinate system Σ_{S}. R may refer to a rotation and transformation matrix. ^{ASUk}dₖ may refer to a displacement of the FM located on the FAA measured by the k^{th} alignment system 140.

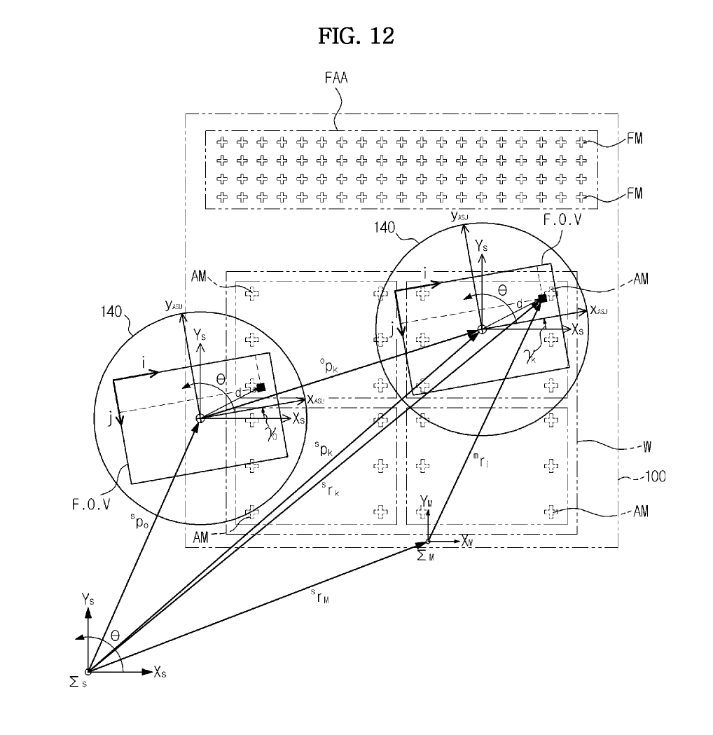

If the central position coordinates of the respective alignment systems 140 according to the installation errors γₖ of the respective alignment systems 140 and the assembly error α of the FAA are acquired, the positions of the AMs engraved on the workpiece W may be acquired using the respective alignment systems 140. This will be described with reference to FIG. 12.

FIG. 12 is a view illustrating a method for acquiring the AMs engraved on the workpiece using alignment systems in a measurement system according to an exemplary embodiment of the present invention.

In FIG. 12, positions ^{S}rₖ of the AMs measured by the respective alignment systems 140 with respect to the stage coordinate system Σ_{S} are defined by Equation 4 below.

^{S}rₖ=^{S}pₖ+R(γₖ)·^{ASUk}d=(^{S}p₀+⁰pₖ)+R(γₖ)·^{ASUk}_{d} [Equation 4]

In Equation 4, ^{S}Pₖ may refer to central coordinates of one or more alignment systems 140 with respect to a stage coordinate system Σ_{S} (e.g., a value obtained through Equation 3 above).

A position ^{S}rᵢₖ of the i^{th} AM measured by the respective alignment systems 140 with respect to the stage coordinate system Σ_{S} is calculated by Equation 5 below.

^{S}rᵢₖ=^{S}pₖ+R(γₖ)·^{ASUk}dᵢ=(^{S}p₀+⁰pₖ)+R(γₖ)·^{ASUk}dᵢ [Equation 5]

In Equation 5, k may refer to a 0^{th}, 1^{st}, 2^{nd}, or . . . n^{th} alignment system 140, and i may refer to a 1^{st}, 2^{nd}, 3^{rd} or . . . n^{th} AM.

The position and posture of the workpiece W may be measured using the position ^{S}rᵢₖ of the i^{th} AM measured by the respective alignment systems 140 with respect to the stage coordinate system Σ_{S}.

Physical quantities of Σ_{O} and Σ_{M} are described in more detail below.

Σ_{O}(X_{O}, Y_{O}) may refer to a reference coordinate system to acquire the position and posture of the workpiece W mounted on the moving table 100, which may be provided on the moving table 100.

Σ_{M}(X_{M}, Y_{M}) may refer to a fixed body coordinate system of the moving table 100 (hereinafter, referred to as a moving coordinate system). The center of the moving coordinate system Σ_{M} may refer to a random point on the moving table 100. The center of the moving coordinate system Σ_{M} may be a position which is significant in design, or be an FM.

Therefore, the position ^{S}rᵢₖ of the i^{th} AM measured by the respective alignment systems 140 with respect to the stage coordinate system Σ_{S} may be calculated, without limitation, by Equation 6.

$$\begin{matrix}{}_{}^{S}{r}{}_{ik}^{} = {}_{}^{S}{p}{}_{k}^{} + R ( {γ}_{k} ) \cdot {}_{}^{ASUk}{d}{}_{i}^{} \\ = ( {}_{}^{S}{p}{}_{0}^{} + {}_{}^{0}{p}{}_{k}^{} ) + R ( {γ}_{k} ) \cdot {}_{}^{ASUk}{d}{}_{i}^{} \\ = {}_{}^{s}{r}{}_{M}^{} + {}_{}^{M}{r}{}_{i}^{}\end{matrix} \qquad [ Equation 6 ]$$

In Equation 6, ^{S}r_{M} may refer to a random position on the moving table 100 with respect to the stage coordinate system Σ_{S}, and is measured by a feedback signal of the stage 110. ^{M}rᵢ may refer to the position of the i^{th} AM measured with respect to the moving coordinate system Σ_{M}.

Therefore, the position ^{M}rᵢ of the i^{th} AM measured with respect to the moving coordinate system Σ_{M} may be calculated, without limitation, by Equation 7.

^{M}rᵢ=−^{S}rₘ+(^{S}p₀+⁰pₖ)+R(γₖ)·^{ASUk}dᵢ [Equation 7]

The position ^{O}rᵢ of the i^{th} AM may define the moving coordinate system Σ_{M} as a reference coordinate system Σ_{O} through Equation 7, and the position ^{O}rᵢ of the i^{th} AM may be calculated, without limitation, by Equation 8 below.

^{O}rᵢ≡^{M}rᵢ=−^{S}rₘ+(^{S}p₀+⁰pₖ)+R(γₖ)·^{ASUk}dᵢ [Equation 8]

In Equation 8, ^{S}r_{M} may refer to a position of the moving table 100 acquired through a feedback signal of the stage 110. (^{S}P₀+⁰Pₖ) may refer to the position ^{S}Pₖ of each of the respective alignment systems (for example, the k^{th} alignment system) 140. R(γₖ)·^{AUSk}dᵢ may refer to image information ^{s}d of the displacement of the i^{th} AM measured by each of the respective alignment systems (e.g., the k^{th} alignment system) 140.

Referring to Equation 8, the position ^{O}rᵢ of the i^{th} AM engraved on the workpiece W may be acquired through the position ^{S}r_{M} of the moving table 100, the position ^{S}Pₖ of each of the respective alignment systems (e.g., the k^{th} alignment system) 140, and the image information ^{s}d acquired through each of the respective alignment systems (e.g., the k^{th} alignment system) 140.

In ^{O}rᵢ may refer to a displacement of the 1^{st}, 2^{nd}, or . . . n^{th} AM.

If the number of acquired positions ^{O}r_{i=1, 2} of the AMs engraved on the workpiece W is two, the position and posture of the workpiece W may be measured. On the other hand, if the number of acquired positions ^{O}r_{i=1, 2} of the AMs engraved on the workpiece W exceeds two, the position and posture of the workpiece W may be measured using a least square method or analysis.

Although exemplary embodiments of the present invention illustrate the positions of ^{O}rᵢ of AMs engraved on the workpiece W as being acquired using the k^{th} alignment system 140, the positions of ^{O}rᵢ of the AMs engraved on the workpiece W may be respectively measured using multiple alignment systems 140. In this case, the positions ^{S}P_{k=0, 1, 2 . . .} of the multiple alignment systems 140 may be determined using steps illustrated in FIG. 8 or FIG. 11, and the image information ^{s}d acquired by the respective alignment systems 140 may be enabled to perform parallel processing (if the respective alignment systems may sequentially and rapidly process the image information, quasi-parallel processing is enabled). If multiple alignment systems 140 are used, the positions of ^{O}rᵢ of the AMs engraved on the workpiece W may be more rapidly acquired, and thus the position and posture of the workpiece W may be measured in a shorter period of time.

Further, although exemplary embodiments of the present invention illustrate the position and posture of the workpiece W as being measured by acquiring the AMs engraved on the workpiece W by moving the moving table 100 while fixing the alignment systems 140. The position and posture of the workpiece W may be measured by acquiring the AMs engraved on the workpiece W by moving the alignment systems 140 while fixing the moving table 100 or by moving both the moving table 100 and the alignment systems 140.

A measurement system using one or more alignment systems and a position measurement method using the same according to exemplary embodiments of the present invention measure the position and posture of a workpiece, such as a substrate (or a semiconductor wafer), by acquiring central position coordinates of the alignment systems. The described method and measurement system may be applicable to various fields of processing/manufacturing/testing of workpieces.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for measuring position information of a workpiece, the method comprising:
measuring position information of a first fiducial mark (FM) using an alignment system;
calculating position information of the alignment system corresponding to a position of a table, wherein the second FM is detected within a field of vision (FOV) of the alignment system;
acquiring image information of the workpiece using the alignment system;
acquiring position information of alignment marks (AMs) disposed on the workpiece using position information of the table; and
measuring position information of the workpiece using the position information of the AMs.

2. The method of claim 1, wherein the table is configured to move in an X-axis direction and a Y-axis direction.

3. The method of claim 1, wherein the alignment system is configured to move in an X-axis direction, a Y-axis direction and a Z-axis.

4. The method of claim 1, wherein a fiducial alignment scope unit mark array (FAA) comprising the first FM and the FM is disposed on the table.

5. The method of claim 1, wherein acquiring position information of the AMs comprises:
sequentially processing the position information of the alignment system and another alignment system; and
sequentially processing position information of the image information acquired using the alignment systems.

6. The method of claim 1, wherein acquiring image information of the workpiece comprises:
calculating an installation error of the alignment system by moving the table so that the second FM is located within the FOV of the alignment system; and
measuring position information of the second FM with respect to a stage coordinate system in the alignment system.

7. The method of claim 1, wherein calculating position information of the alignment system comprises:
acquiring the position information of the table through a feedback signal of a stage if the second FM is located within the FOV of the alignment system.

8. The method of claim 1, wherein calculating position information of the alignment system comprises:
calculating the position information of the alignment system having the first FM located within its FOV.

9. The method of claim 6, wherein acquiring position information of the AMs comprises:
acquiring position coordinates of the AMs through position coordinates of the table, the position coordinates of the alignment systems, and the image information.

10. The method of claim 9, wherein measuring position information of the workpiece comprises:
measuring the position information of the workpiece by acquiring two or more position coordinates of the AMs.

11. A measurement system, comprising:
a table to support a workpiece;
a fiducial alignment scope unit mark array (FAA) comprising a first fiducial mark (FM) and a second FM, the FAA disposed on the table;
an alignment system configured to measure position information of the first FM; and
a control unit configured to calculate position information of the alignment system corresponding to a position of the table, to acquire image information of the workpiece using the alignment system, to acquire position information of alignment marks (AMs) on the workpiece based on the position of the table, and to calculate the position information of the workpiece using the position information of the AMs,
wherein the position of the table corresponds to a position where the second FM is detected within a field of vision (FOV) of the alignment system.

12. The measurement system of claim 11, wherein the alignment system comprises alignment scope units to measure position coordinates of the FMs and the AMs.

13. The measurement system of claim 11, further comprising another alignment system.

14. The measurement system of claim 11, wherein the FMs are used to acquire coordinates of the alignment system.

15. The measurement system of claim 11, wherein the FAA is manufactured in an array and the FMs are arranged at a reference interval.

16. The measurement system of claim 11, wherein the control unit calculates an installation error of the alignment system by moving the table so that the second FM is located within the FOV of the alignment system, and acquires the image information of the workpiece by measuring position information of the second FM with respect to a stage coordinate system.

17. The measurement system of claim 11, wherein the control unit calculates position coordinates of the alignment system by acquiring the position information of the table through a feedback signal of a stage if the second FM is located within the FOV of the alignment system.

18. The measurement system of claim 16, wherein the control unit acquires position coordinates of the AMs on the workpiece through position coordinates of the table, the position coordinates of the alignment system, and the image information.

19. The measurement system of claim 18, wherein the control unit measures the position information of the workpiece by acquiring position coordinates of the AMs.

20. A measurement system, comprising:
a workpiece comprising a plurality of alignment marks (AMs);
a fiducial alignment scope unit mark array (FAA) comprising a first fiducial mark (FM) and a second FM;
an alignment system configured to measure position information of the first FM; and
a control unit configured to calculate position information of the alignment system by detecting the second FM to be within a field of vision (FOV) of the alignment system, and to acquire position information of the workpiece by detecting the AMs to be within the FOV of the alignment system.
